(19) United States
(12) Patent Application Publication
(10) Pub. No.: US 2011/0203232 A1
(43) Pub. Date: Aug. 25, 2011

(54) GIRTH FOR HORSE SADDLES

(76) Inventors: Constantino SANCHEZ MARTINEZ, Midrid (ES); Gustavo Sugliano Olivera, Atlantida (UY)

(21) Appl. No.: 13/124,307

(22) PCT Filed: Nov. 23, 2009
(86) PCT No.: PCT/ES2009/070519

§ 371 Date: Apr. 14, 2011

(30) Foreign Application Priority Data
Nov. 25, 2008 (ES) U200802426

(51) Int. Cl. B68C 1/14

(52) U.S. Cl. 54/23

(57) ABSTRACT

The invention relates to a girth for horse saddles which allows distributing pressure proportionally on the body of the animal, it being adapted to the geometry of the animal during physical exercise, made up of a main girth body (1) with V-shaped die-cuts (5), articulating thereto several straps (2) and buckles (3), wherein each of the straps (2) is independently joined to several elastic rings (4), which are secured on the outer and central part of said girth, each of the elastic rings (4) acting independently for each of the straps (2) incorporating at their ends several perforations (6) for fixing the length thereof by means of screw pins (7), which in turn allow interchanging the buckles (3); having special application in the equestrian sector where a girth having said features is required.

### BACKGROUND OF THE INVENTION

1. Field of the Invention

The object of the present invention patent is to present a new girth for horse saddles, providing a girth with four elastic rings completely independent from one another, together with adjustable straps and interchangeable buckles, with several V-shaped die-cuts articulating it, therefore allowing a multipurpose use of the girth.

This new girth for horse saddles has a special application in the equestrian sector where a girth having said features is required.

2. Description of the Related Art

Until now, there have been many girths for horse saddles which are rigid, therefore they exert a continuous pressure on the body of the animal in addition to not being able to be adapted to the geometry of the animal when it performs exercise and expands its lungs, these girths only allow adjusting their length by means of the different positions of the buckles thereof on the saddle to which they are coupled.

There are several types of girths which, in order to avoid this problem, have several straps with elastic ends, which in a certain way reduces the effort that must be exerted for girthing, however, the pressure felt by the horse is identical to that of rigid girths. Girths with elastic rings in a ventral position but joining a strap with the opposite strap, which do not allow a completely independent action of each of them, are also described.

The current state of the art does not describe any type of girth for horse saddles such as the one described in the present invention patent.

### SUMMARY OF THE INVENTION

To overcome or, where appropriate, to eliminate the aforementioned problems, this new girth for horse saddles made is up of a body with several V-shaped die-cuts which allow articulating the girth is presented, in the middle of said body there are several independently fixed elastic rings, each of which is fixed independently by one of its ends to the central part of the body and by the other end to a strap. The straps have at their two ends a series of perforations, where several screw pins are fixed for adjusting the length of said straps, which therefore allows interchanging the fastening buckles of the saddle.

One of the main advantage provided by this invention is to ensure a secure fastening of the saddle on the horse, both when the animal is resting and while it performs physical exercises because it adapts to the horse's anatomy at all times and under all circumstances.

The elastic rings are independent for each of the straps, i.e., upon pulling one of the straps, the opposite strap is not dragged along since they are not joined to one another.

The elastic rings are in each of the straps of the girth and are independently fixed in the central part thereof.

As a result of its V-shaped die-cuts, the girth is automatically articulated, adapting a more or less prominent V-shape, depending on the place where the saddle is placed and on the shape of the horse.

The entire girth is manufactured with no seams, therefore it can be completely disassembled, changing the elastic rings, the straps, the buckles and the protective cover being allowed when deemed necessary.

As a result of incorporating at the ends of the straps a series of perforations for fixing the length thereof by means of several screw pins, different girth sizes for different horse sizes are not necessary, adjusting the length of said straps being allowed in a completely independent manner.

As the buckles can be interchanged, their use with any other type of saddle is made easy.

Both the girth body and the interchangeable protective cover have a series of perforations to allow evaporation of the horse's perspiration, preventing possible irritations and overheating in the area where it is supported.

### BRIEF DESCRIPTION OF THE DRAWINGS

To complement the description that is being made and for the purpose of aiding to better understand the features of the invention, a drawing is attached to the present specification as an integral part thereof in which the following has been depicted with an illustrative and non-limiting character:

FIG. 1 is a view of the girth for horse saddles object of the present invention patent.

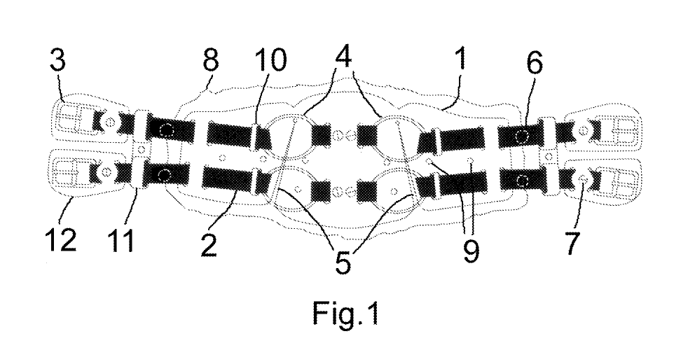

### DETAILED DESCRIPTION OF THE EMBODIMENTS OF THE INVENTION

As can been seen in the attached figure, the girth for horse saddles is made up of the main girth body (1), several straps (2) with elastic rings (4) and several buckles (3).

Each strap (2) is joined to an elastic ring (4) completely independently from one another, each of the elastic rings (4) always working integrally with its corresponding strap (2).

The main girth body (1) has several V-shaped die-cuts (5).

The straps (2) incorporate at their ends several perforations (6) for fixing the length thereof by means of the screw pins (7).

The buckles (3) are interchangeable by means of the screw pins (7).

Both the main girth body (1) and the interchangeable protective cover (8) have a series of perforations (9).

The straps (2) incorporate several stops (10) which limit the extension of the elastic rings (4).

The straps (2) from the main girth body (1) are joined to the independent protectors (12) of the buckles (3) by means of several guiding pins (11).

Having sufficiently described the nature of the present invention as well as a way of carrying it out to practice, it merely remains to be added that said invention may experience certain variations in the shape and materials, provided that said alterations do not substantially vary the features which are claimed below.

What is claimed is:

1. A girth for horse saddles having a main girth body (1), a plurality of straps (2) with elastic rings (4) and several buckles (3), characterized in that each strap (2) is joined to an elastic ring (4) and this in turn is fixed by its other end to the girth body, without it being able to slip, each of the elastic rings (4) always working integrally with a corresponding cooperating strap (2).

2. The girth for horse saddles according to claim 1, characterized in that the main girth body (1) has several V-shaped die-cuts (5) which allow the articulation of the girth body.

3. The girth for horse saddles according to claim 1, characterized in that the straps (2) incorporate at their ends several perforations (6) for fixing the length thereof by means of screw pins (7).

4. The girth for horse saddles according to claim 1, characterized in that the buckles (3) are interchangeable by means of the screw pins (7).

5. The girth for horse saddles according to claim 1, characterized in that both the main girth body (1) and the interchangeable protective cover (8) have a series of perforations (9).

6. The girth for horse saddles according to claim 1, characterized in that the straps (2) incorporate several stops (10) limiting the extension of the elastic rings (4).

7. The girth for horse saddles according to claim 1, characterized in that the straps (2) from the main girth body (1) are joined to the independent protectors (12) of the buckles (3) by means of several guiding pins (11).
